(19) United States
(12) Patent Application Publication
(10) Pub. No.: US 2017/0180776 A1
(43) Pub. Date: Jun. 22, 2017

(54) INFORMATION ACQUISITION APPARATUS, INFORMATION ACQUISITION METHOD AND COMPUTER-READABLE STORAGE MEDIUM

(71) Applicant: CASIO COMPUTER CO., LTD., Tokyo (JP)

(72) Inventor: Fuminobu NAKAMURA, Tokyo (JP)

(73) Assignee: CASIO COMPUTER CO., LTD., Tokyo (JP)

(21) Appl. No.: 15/270,210

(22) Filed: Sep. 20, 2016

(30) Foreign Application Priority Data
Dec. 21, 2015 (JP) 2015-248812

(51) Int. Cl. H04N 21/422; H04N 21/81; H04N 21/435

(52) U.S. Cl. CPC H04N 21/42222; H04N 21/435; H04N 21/812

(57) ABSTRACT

An information acquisition apparatus including a detection section which detects a movement of the information acquisition apparatus, a reception section which receives identification information transmitted from an external apparatus and indicating output information that is being outputted to the external apparatus, a reception control section which controls the reception section to receive the identification information when the detection section detects a predetermined movement; and an information reception section which receives information related to the output information that is being outputted to the external apparatus and indicated by the identification information, when the reception section receives the identification information.

### CROSS-REFERENCE TO RELATED APPLICATION

This application is based upon and claims the benefit of priority from the prior Japanese Patent Application No. 2015-248812, filed Dec. 21, 2015, the entire contents of which are incorporated herein by reference.

### BACKGROUND OF THE INVENTION

1. Field of the Invention

The present invention relates to an information acquisition apparatus, an information acquisition method and a computer-readable storage medium.

2. Description of the Related Art

With the prevalence of portable terminals such as multi-functional portable telephones (smartphones), the distribution of content such as an advertisement to users' portable terminals for display has been performed. The content herein is a group of information meaningful to humans, which is recorded and transmitted by a medium or a network.

For example, Japanese Patent Application Laid-Open (Kokai) Publication No. 2013-134494 discloses a technology for advertisement providing systems in which, when a portable terminal is moved with first content distributed to the terminal being displayed on its screen, second content is distributed and displayed on the screen in place of the first content.

In this technology, when a user who is interested in the first content moves the portable terminal, the second content is displayed in place of the first content. For example, by simple information (such as an announcement about a new product) being set as the first content and more detailed information (such as detailed description of the new product) being set as the second content, a content publicizing effect (such as an advertising effect) can be enhanced.

However, this technology is merely a technology where contents to be displayed is switched in response to the movement of a portable terminal, and there is room for improvement in that it is not taking into consideration the motion of a person viewing the display of, for example, a so-called digital signage terminal (hereinafter simply referred to as a signage terminal) which displays characters, images, moving pictures, or mixture information thereof on a liquid-crystal panel, projector, or the like.

### SUMMARY OF THE INVENTION

An object of the present invention is to provide an information acquisition apparatus, an information acquisition method and a computer-readable storage medium where the motion of a person viewing a signage terminal has been taken into consideration.

In accordance with one aspect of the present invention, there is provided an information acquisition apparatus comprising: a detection section which detects a movement of the information acquisition apparatus; a reception section which receives identification information transmitted from an external apparatus and indicating output information that is being outputted to the external apparatus; a reception control section which controls the reception section to receive the identification information when the detection section detects a predetermined movement; and an information reception section which receives information related to the output information that is being outputted to the external apparatus and indicated by the identification information, when the reception section receives the identification information.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a conceptual structure diagram showing a content distribution system in an embodiment;

FIG. 2 is a conceptual structure diagram showing a signage terminal 4;

FIG. 3 is a conceptual structure diagram showing a server 2;

FIG. 4 is a conceptual structure diagram showing a user terminal U; and

FIG. 5 is a diagram for describing the operation of the embodiment.

### DETAILED DESCRIPTION OF THE PREFERRED EMBODIMENT

An embodiment of the present invention will hereinafter be described with reference to the drawings.

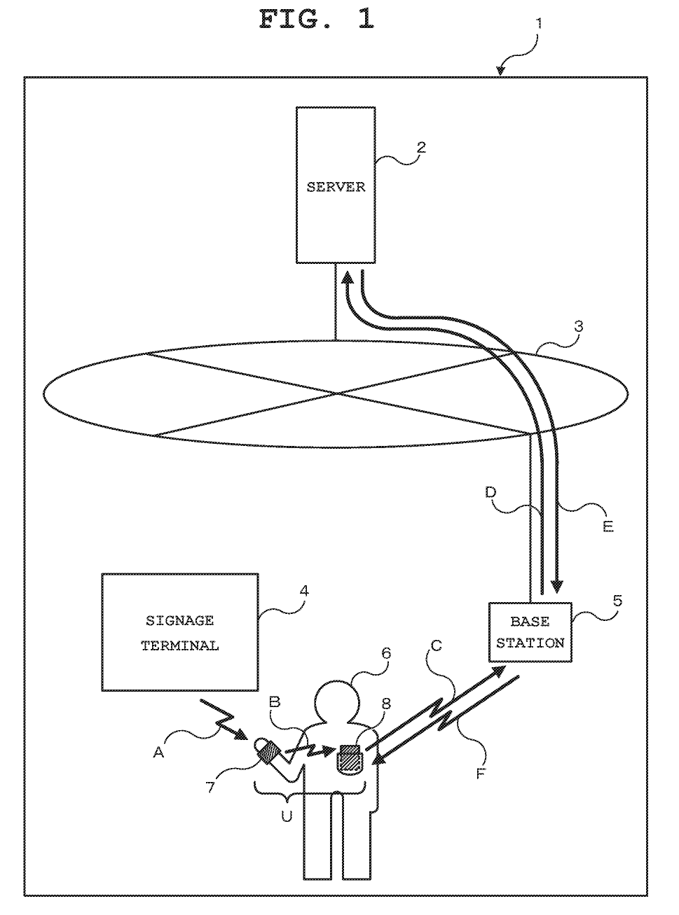

FIG. 1 is a conceptual structure diagram showing a content distribution system of the present embodiment.

This content distribution system 1 is structured to include a server 2, a network 3, a signage terminal 4 (content display apparatus), a base station 5, and a user terminal U which moves together with a user 6. In the present embodiment, the user terminal U is constituted by a wrist terminal 7 that is worn on an arm of the user 6 and a portable terminal 8 that is carried by the user 6.

Note that, in practice, each of the signage terminal 4, the base station 5, and the user terminal U in the drawing is plurally provided. However, here, only one representative example is shown for each of them.

The signage terminal 4 is constituted by a large display apparatus such as a liquid-crystal panel or projector, which is installed at various places including a street corner, a public facility such as an airport and an station, a shop, and the wall surface of a building so as to display arbitrary content. Note that the arbitrary content described below is “advertisement” for convenience of description, but not limited thereto.

The advertisement has contents appropriate to the installation place of the signage terminal 4 (for example, product information when the installation place is a shop), and the contents of the advertisement are switched at predetermined time intervals, random time intervals, or any timing for each signage terminal 4. For example, switching is performed to an advertisement A, an advertisement B, an advertisement C, . . . at intervals of several minutes. The contents such as advertisements may be still pictures, moving pictures, characters, or a mixture thereof. Alternatively, the contents may include audio data such as narration and BGM (background music).

The signage terminal 4 wirelessly transmits, to an area around the signage terminal 4, unique information (hereinafter referred to as a content ID (identification information)) for identifying an advertisement being displayed. The “area around the signage terminal 4” refers to, for example, an area where an advertisement displayed on the signage terminal 4 is viewable. In general, this area is particularly defined in accordance with the screen size of the signage terminal. For example, when the screen size is several tens of inches, this area is a nearby area of several meters to over ten meters. Alternatively, when the screen size is so large as to cover the wall surface of a building, this area may be an area including an intermediate/long distance range of several tens of meters or longer.

For example, for the above-described nearby area, short-distance wireless communication such as Bluetooth (registered trademark) can be used as a communication medium for use in wireless transmission. For the above-described area including a intermediate/long distance range, intermediate/long-distance wireless communication can be used, such as Wi-Fi (Wireless Fidelity) (registered trademark) or low-power wireless communication. That is, an appropriate communication medium in accordance with the distance is selected.

The wrist terminal 7 is, for example, a wristwatch-type terminal that is also referred to as a smartwatch. This wrist terminal 7 has a function for cooperation with a multifunctional portable telephone (portable terminal 8) such as a smartphone (for example, a notification function as to the reception of incoming calls and E-mails by the portable terminal 8), in addition to basic functions as a watch. Furthermore, in the present embodiment, the wrist terminal 7 has a function of judging whether the user 6 is viewing an advertisement on the signage terminal 4, a function of receiving a content ID transmitted from the signage terminal 4 when the user 6 is judged to be viewing the advertisement, and a function of notifying the portable terminal 8 of the received content ID.

The portable terminal 8 is a multifunctional portable telephone such as a smartphone, and has a telephone function of calling to and from another telephone (such as a portable telephone or subscriber telephone) via a nearest base station 5 and a function of using various services (such as services for viewing E-mails and homepages) provided via the network 3. Also, the portable terminal 8 has a function of downloading and displaying related data (advertisement information) of an advertisement being displayed on the signage terminal 4 from the server 2 by using a content ID provided from the wrist terminal 7.

The related data (advertisement information) herein is other content associated with an advertisement (content) being displayed on the signage terminal 4 in a one-to-one relation. For example, when an advertisement being displayed on the signage terminal 4 is an advertisement briefly describing a product, the related data is content which more specifically describes the product. Also, a plurality of pieces of related data (advertisement information) may be associated with one content ID, or one piece of related data (advertisement information) may be associated with a plurality of content IDs.

The base station 5 is one of many cellular wireless relay stations operated by a communication company of the portable terminal 8. This base station 5 is connected to a telephone station not shown, and is further connected to the server 2 via the network 3.

The network 3 is a global wide-area network such as the Internet, to which various servers including the server 2 shown in the drawing and terminals not shown in the drawing are connected.

The server 2 is unique to the present embodiment. In particular, when a predetermined notification is received from the portable terminal 8, the server 2 transmits information corresponding to a content ID included in the notification (related data (advertisement information) of an advertisement being displayed on the signage terminal 4) to the portable terminal 8 as a notification source.

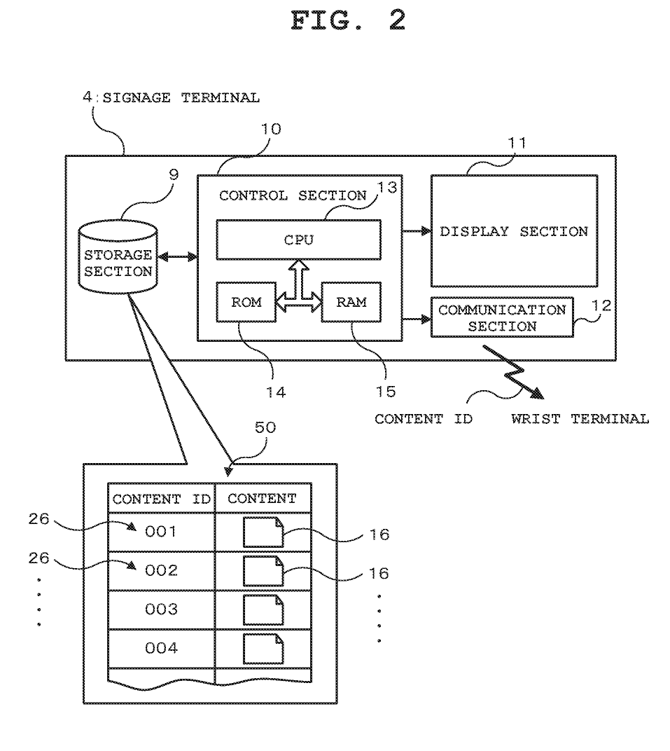

FIG. 2 is a conceptual structural diagram of the signage terminal 4. The signage terminal 4 includes a storage section 9, a control section 10, a display section 11, and a communication section 12.

The storage section 9 is a storage device for storing various content (advertisements), such as a hard disk, a USB (Universal Serial Bus) memory, a flash memory, a silicon disk, a magnetic disk, and an optical disk. In this storage section 9, a table 50 is stored in which entity data 16 of each content (advertisement) and identification information (content ID) 26 thereof are associated in a one-to-one relation.

The control section 10 includes a CPU (Central Processing Unit) 13 for executing various programs stored in a read-only semiconductor memory (Read Only Memory, hereinafter abbreviated as a ROM) 14 so as to perform a predetermined arithmetic operation or control processing for each section, and a RAM (Random Access Memory) 15 that serves as a working area at the time of program execution. This control section 10 loads software resources such as a basic program (Operating System: OS) and application programs (various-purpose application programs which are also simply referred to as applications) stored in advance in the ROM 14 onto the RAM 15, and the CPU 13 executes these software resources. As a result, functions unique to the signage terminal 4 are achieved, such as a function of reading content (advertisements) stored in the storage section 9 sequentially, randomly, or in a predetermined sequence for display on the display section 11 and a function of transmitting identification information (content ID) of content (advertisement) being displayed to areas around the signage terminal 4 by the communication section 12. Note that one or more CPUs 13 may be provided.

The display section 11 is a display device having a large screen such as a liquid-crystal panel or a projector, and displays information (contents) received from the control section 13.

The communication section 12 is a device which transmits identification information (content ID) of content (advertisement) being displayed on the display section 11 to areas around the signage terminal 4, such as a Bluetooth (registered trademark), Wi-Fi, or low-power wireless section.

The signage terminal 4 may include, for cases where audio data is in content (advertisement), an audio output section for outputting audio data.

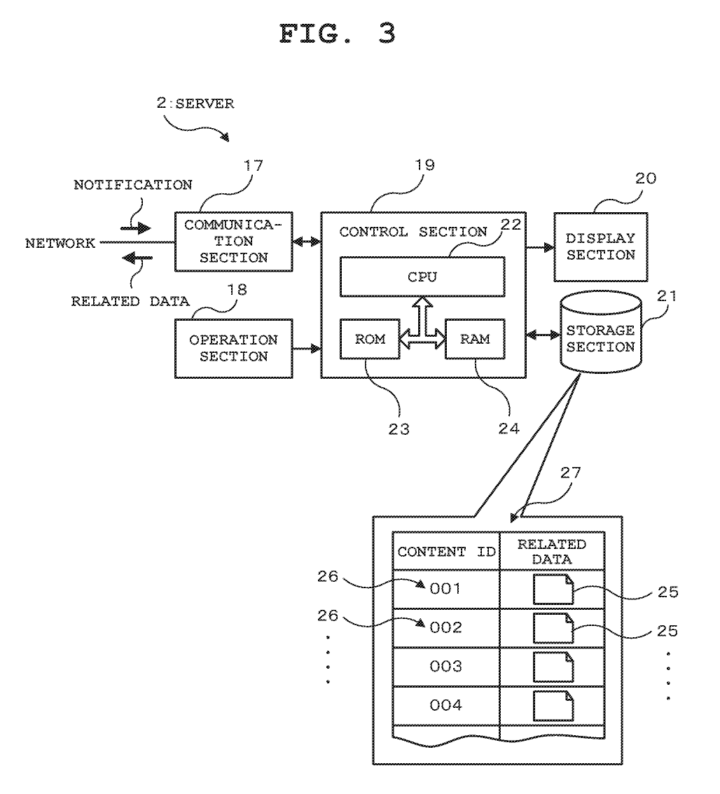

FIG. 3 is a conceptual structure diagram of the server 2. The server 2 includes a communication section 17, an operation section 18, a control section 19, a display section 20, and a storage section 21.

The communication section 17 is a communication device which exchanges data with the portable terminal 8 via the network 3. The operation section 18 is a user interface device such as a keyboard or a mouse.

The control section 19 includes a CPU 22 which executes various programs stored in a ROM 23 so as to perform a predetermined arithmetic operation or control processing for each section, and a RAM 24 that serves as a working area at the time of program execution. This control section 19 loads software resources such as a basic program (OS) and application programs (various-purpose application programs which are also simply referred to as applications) stored in advance in the ROM 23 onto the RAM 24, and the CPU 22 executes these software resources. As a result, functions of the server 2 are achieved, such as a function of receiving a notification from the portable terminal 8, and a function of extracting related data (advertisement information) from the storage section 21 by using a content ID included in the notification and transmitting the related data (advertisement information) to the portable terminal 8 as a notification source. Note that the software resources such as the OS and the application programs may be stored not in the ROM 23 but in a storage device such as a hard disk (for example, the storage section 21). Also note that one or more CPUs 22 may be provided.

The display section 20 is a display device such as a liquid-crystal panel, and displays the operation management status of the server 2 and the like.

The storage section 21 is a large-capacity storage device for storing content IDs of various content (advertisements) stored in the storage section 9 of the signage terminal 4 and related data (advertisement information), such as a hard disk. In this storage section 21, a table 27 is stored in which related data 25 and content IDs 26 are associated with each other. For example, in this table 27, content IDs and related data may be stored in a one-to-one relation, as shown in FIG. 3.

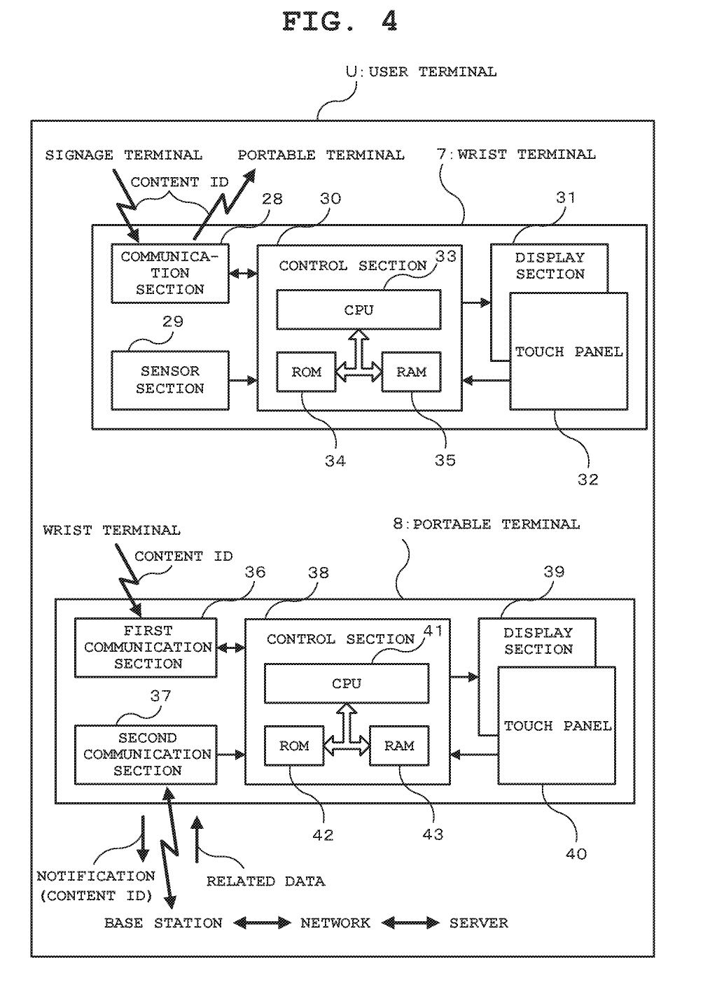

FIG. 4 is a conceptual structure diagram of the user terminal U. The user terminal U is constituted by the wrist terminal 7 that is worn on an arm of the user 6 and the portable terminal 8 that is carried by the user 6. The wrist terminal 7 includes a communication section 28, a sensor section 29, a control section 30, a display section 31, and a touch panel 32.

The communication section 28 is a transmission/reception device which receives identification information (content ID) transmitted from the communication section 12 of the signage terminal 4 and transmits its content ID to the portable terminal 8, such as a Bluetooth (registered trademark), Wi-Fi, or small-power wireless section.

The sensor section 29 includes an acceleration sensor, a gyro sensor, and the like which detect the movement of the wrist terminal 7, or in other words, the motion (such as a swing) of the arm of the user 6 wearing the wrist terminal 7.

The control section 30 includes a CPU 33 which executes various programs stored in a ROM 34 so as to perform a predetermined arithmetic operation or control processing for each section, and a RAM 35 that serves as a working area at the time of program execution. The control section 30 loads software resources such as a basic program (OS) and application programs (various-purpose application programs which are also simply referred to as applications) stored in advance in the ROM 34 onto the RAM 35, and the CPU 33 executes these software resources. As a result, basic functions (such as functions as a watch) of the wrist terminal 7 are achieved. Moreover, the control section 30 actualizes a function of judging, based on a result of detection by the sensor section 29, whether the arm swing of the user 6 is in a predetermined state (hereinafter referred to as a judging function), and actualizes a function of determining whether to receive a content ID transmitted from the signage terminal 4 by the communication section 28 (hereinafter referred to as reception control means). When a result of judgment by the judging function is YES, the reception control means determines that the communication section 28 receives a content ID, and the reception of the content ID is performed. Furthermore, the control section 30 actualizes a function of transmitting a content ID to the portable terminal 8 by the communication section 28.

The display section 31 is a display device such as a liquid-crystal panel, and displays time and other information. The touch panel 32 detects touch coordinates and a touch pattern on the display apparatus.

The portable terminal 8 includes a first communication section 36, a second communication section 37, a control section 38, a display section 39, and a touch panel 40.

The first communication section 36 is, for example, a Bluetooth (registered trademark), Wi-Fi, or low-power wireless section, which receives identification information (content ID) transmitted from the communication section 28 of the wrist terminal 7.

The second communication section 37 transmits and receives telephone audio data, E-mails, and digital data related to the Internet or the like to and from a nearest base station 5. Also, in the present embodiment, the second communication section 37 transmits a content ID to the server 2 connected to the network 3, and receives related data (advertisement information) transmitted from the server 2.

The control section 38 includes a CPU 41 which executes various programs stored in a ROM 42 so as to perform a predetermined arithmetic operation or control processing for each section, and a RAM 43 that serves as a working area at the time of program execution. The control section 38 loads software resources such as a basic program (OS) and application programs (various-purpose application programs which are also simply referred to as applications) stored in advance in the ROM 42 onto the RAM 43, and the CPU 41 executes these software resources. As a result, basic functions (such as a telephone function) of the portable terminal 8 are achieved. Furthermore, the control section 38 actualizes a function of receiving a content ID transmitted from the wrist terminal 7 by the first communication section 36, a function of transmitting the content ID received by the first communication section 36 to the server 2 for notification via the base station 5 and the network 3 by using the second communication section 37, a function of receiving related data (advertisement information) transmitted from the server 2 in response to this notification by the second communication section 37, and a function of causing the received related data (advertisement information) to be displayed on the display section 39.

The display section 39 is a display device such as a liquid-crystal panel, and displays telephone numbers of outgoing and incoming telephone calls and the above-described related data (advertisement information). The touch panel 40 detects touch coordinates and a touch pattern on the display apparatus.

Next, the operation of the content distribution system 1 is schematically described.

In FIG. 1, when an arbitrary advertisement is being displayed on the signage terminal 4, if the user 6 who is interested in this advertisement stops or slows down the walking speed to view the display screen of the signage terminal 4, the amount of the arm swing of the user 6 becomes zero or subtle.

This arm swing of the user is detected by the sensor section 29 of the wrist terminal 7 as the movement of the wrist terminal 7 (no movement or subtle movement). When this movement is detected, the wrist terminal 7 receives the content ID (the identification information of the advertisement being displayed) transmitted (arrow A) from the signage terminal 4, and notifies the portable terminal 8 of the content ID (arrow B).

Also, when a state is detected in which the movement of the wrist terminal 7 is not large, the wrist terminal 7 may receive the content ID (the identification information of the advertisement being displayed) transmitted (arrow A) from the signage terminal 4, and notify the portable terminal 8 of the content ID (arrow B).

When the content ID transmitted from the wrist terminal 7 is received, the portable terminal 8 notifies the server 2 of the content ID via the nearest base station 5 and the network 3 (arrows C and D). Next, in response to this notification, the server 2 transmits related data (data related to the advertisement being displayed on the signage terminal 4) corresponding to the content ID to the portable terminal 8 which is the notification source (arrows E and F). Then, the portable terminal 8 causes the related data (advertisement information) to be displayed on the display section 39.

According to this content distribution system 1, when the user 6 carrying the user terminal U (the wrist terminal 7 and the portable terminal 8) stops walking to view the screen of the signage terminal 4, related data (advertisement information) of an advertisement being displayed on the screen of the signage terminal 4 is displayed on the screen of the portable terminal 8. As a result of this configuration, by the cooperation of the signage terminal 4 and the portable terminal 8, a content publicizing effect (such as an advertising effect) appropriate for preferences of the user 6 can be achieved.

The above operation can be achieved by the following processing flow.

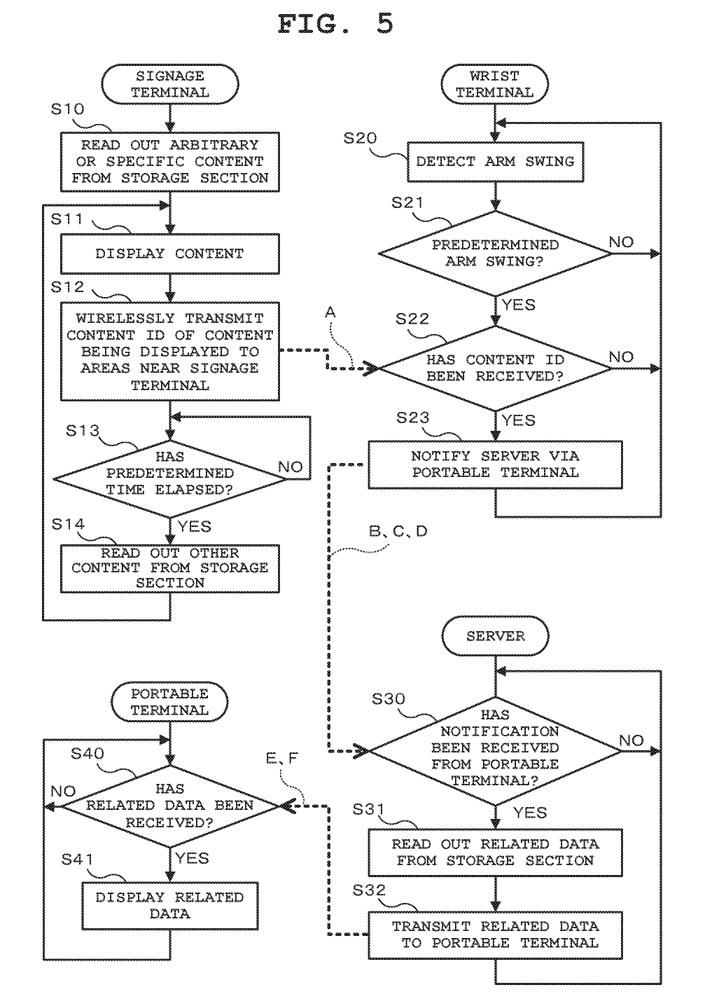

FIG. 5 is a diagram for describing the operation of the present embodiment. In this drawing, the processing flow of the control section 10 of the signage terminal 4 is shown on the upper left, the processing flow of the control section 30 of the wrist terminal 7 is shown on the upper right, the processing flow of the control section 19 of the server 2 is shown on a lower right, and the processing flow of the control section 38 of the portable terminal 8 is shown on the lower left.

The control section 10 of the signage terminal 4 first reads out arbitrary or specific content from the storage section 9 (Step S10), causes its content to be displayed (Step S11), and transmits the identification information (content ID) of the content being displayed to areas around the signage terminal 4 (arrow A) (Step S12). Then, when a predetermined time elapses (YES at Step S13), the control section 10 reads out the next content from the storage section 9 (Step S14), and causes the content to be displayed (Step S11). Hereafter, the control section 10 repeats these processing operations.

The control section 30 of the wrist terminal 7 detects the way of the arm swing of the user 6 (Step S20). When the arm swing is in a predetermined arm swing state (zero arm swing or subtle arm swing) (YES at Step S21), the control section 30 judges whether to receive a content ID from the signage terminal 4 (Step S22). Then, when the content ID is received (arrow A), the control section 30 transmits the content ID to the portable terminal 8 (arrow B, C, D) (Step S23). Hereafter, the control section 30 repeats these processing operations.

The control section 19 of the server 2 judges whether a notification has been received from the portable terminal 8 (Step S30). When judged that a notification (arrow B, C, D) has been received, the control section 19 reads out related data (advertisement information) from the storage section 21 by using a content ID included in the notification (Step S31). Then, the control section 19 transmits the related data (advertisement information) to the portable terminal 8 which is the notification source (arrow E, F) (Step S32). Hereafter, the control section 19 repeats these processing operations.

The control section 38 of the portable terminal 8 judges whether related data (advertisement information) has been transmitted from the server 2 (Step S40). When judged that related data has been transmitted (arrow E, F), the control section 38 causes the related data (advertisement information) to be displayed on the display section 39 (Step S41). Hereafter, the control section 38 repeats these processing operations.

While the present invention has been described with reference to the preferred embodiment, it is intended that the invention be not limited by any of the details of the description therein but includes all the embodiments which fall within the scope of the appended claims.

For example, the user terminal U can be constituted by only the portable terminal 8, in place of the combination of the wrist terminal 7 and the portable terminal 8. That is, a configuration may be adopted in which a content ID from the signage terminal 4 is directly received by the first communication section 36 of the portable terminal 8. In this configuration, the portable terminal 8 is required to include the function of the sensor section 29 of the wrist terminal 7.

Also, the user terminal U may be achieved by a combination of three or more terminals. That is, the user terminal U may be constituted by three terminals: a receiver which receives a content ID transmitted from the signage terminal 4; a detector which detects the motion of the user 6; and an advertisement information provider which receives and displays advertisement information based on the content ID.

Moreover, the content to be displayed on the display section 11 of the signage terminal 4 may be distributed from the server 2 via the network 3.

Furthermore, the portable terminal 8 may be other than a smartphone. For example, it may be a tablet computer or a portable game machine having a communication function.

In the above-described embodiment, a case has been described in which the motion of the user 6 is detected by the sensor section 29 of the wrist terminal 7, and the movement of the wrist terminal 7 is detected as no movement or a subtle movement. However, the present invention is not limited thereto. That is, a configuration is possible in which the user 6 is judged to be interested in an advertisement being displayed by the signage terminal 4 on condition that the arm swing is slower than normal for a predetermined period of time or the orientation of the motion has been changed. Therefore, the condition can be changed as appropriate.

Moreover, in the above-described embodiment, the user terminal U receives related data (advertisement information) from the server 2. However, the present invention is not limited thereto. That is, a configuration may be adopted in which pieces of related data (advertisement information) corresponding to content IDs are stored in advance in the portable terminal 8, and corresponding related data is read out and displayed on the display section 39 based on a received content ID.

Also, a configuration may be adopted in which related data (advertisement information) is received from the signage terminal 4 and displayed. In this configuration, content IDs and their corresponding related data (advertisement information) are stored in advance in the storage section 9 of the signage terminal 4.

What is claimed is:

1. An information acquisition apparatus comprising:
a detection section which detects a movement of the information acquisition apparatus;
a reception section which receives identification information transmitted from an external apparatus and indicating output information that is being outputted to the external apparatus;
a reception control section which controls the reception section to receive the identification information when the detection section detects a predetermined movement; and
an information reception section which receives information related to the output information that is being outputted to the external apparatus and indicated by the identification information, when the reception section receives the identification information.

2. The information acquisition apparatus according to claim 1, wherein the detection section detects whether an arm swing of a user is in a predetermined state, and the reception control section controls the reception section to receive the identification information when the detection section detects that the arm swing is in the predetermined state.

3. The information acquisition apparatus according to claim 1, wherein the information reception section receives information stored in association with the identification information and related to the output information being outputted to the external apparatus.

4. The information acquisition apparatus according to claim 2, wherein the information reception section receives information stored in association with the identification information and related to the output information being outputted to the external apparatus.

5. The information acquisition apparatus according to claim 2, wherein the predetermined state is a state where the arm swing of the user is not large.

6. An information acquisition method that is performed by an information acquisition apparatus including a detection section which detects a movement of the information acquisition apparatus and a reception section which receives identification information transmitted from an external apparatus and indicating output information that is being outputted to the external apparatus, comprising:
a reception control step of controlling the reception section to receive the identification information when the detection section detects a predetermined movement; and
an information reception step of receiving information related to the output information that is being outputted to the external apparatus and indicated by the identification information, when the reception section receives the identification information.

7. A non-transitory computer-readable storage medium having stored thereon a program that is executable by a computer in an information acquisition apparatus including a detection section which detects a movement of the information acquisition apparatus and a reception section which receives identification information transmitted from an external apparatus and indicating output information that is being outputted to the external apparatus, the program being executable by the computer to actualize functions comprising:
reception control processing for controlling the reception section to receive the identification information when the detection section detects a predetermined movement;
information reception processing for receiving information related to the output information that is being outputted to the external apparatus and indicated by the identification information, when the reception section receives the identification information.
